(19) United States
(12) Patent Application Publication
(10) Pub. No.: US 2009/0120719 A1
(43) Pub. Date: May 14, 2009

(54) AERODYNAMIC LADDER COVER AND TOOL BAG

(76) Inventor: DOUGLAS A. FOULKE, Perkasie, PA (US)

Correspondence Address: GREGORY J. GORE, 70 WEST OAKLAND AVENUE, SUITE 316, DOYLESTOWN, PA, 18901, US

(21) Appl. No.: 11/939,597

(22) Filed: Nov. 14, 2007

(51) Int. Cl. E06C 5/32

(52) U.S. Cl. 182/129

(57) ABSTRACT

An aerodynamic ladder cover has been devised to provide an aerodynamic shape to the leading edges of a ladder while in transport. The cover includes a rigid curved forward-facing nosepiece. The nosepiece is substantially semi-cylindrical and its rigidity maintains a smooth-contoured convex surface facing the wind. In one embodiment of the invention, the rigid nosepiece is provided as an insert within layers of a soft cover overlying material. In this embodiment of the invention, the ladder cover is attached to the ladder by straps which extend from a back end of the cover. The construction of the ladder cover and straps permits the cover to be conveniently used as a contractor's tool bag.

### FIELD OF THE INVENTION

This invention relates to aerodynamic coverings for articles carried on top of a vehicle. In particular, it relates to a covering for a ladder with an alternate use as a tool bag.

### BACKGROUND OF THE INVENTION

Ladders are common equipment used in the construction industry. These ladders are most commonly an extension type transported to the construction site on a vehicle rooftop rack. As such, they are exposed to the wind and other driving elements while they are in transport. A problem exists in that while in transport the ladders create a great deal of wind noise and vibration, especially at high speeds. This can be extremely annoying to the occupants of the vehicle and also can be destructive to the ladder. In addition, the non-aerodynamic shape of the typical ladder adds aerodynamic drag to the vehicle which wastes energy and increases the vehicle's fuel consumption.

There have been attempts to protect the ladder's parts from damaging weather conditions such as ice, snow, rain or sunlight during transport. An example of such devices is shown in U.S. Pat. No. 5,682,960 entitled “Ladder Jacket” issued to Mobley et al. While this device provides a protective covering for a ladder during transport, the fact that it is made entirely of a soft material means it is not capable of presenting an aerodynamic shape in the forward facing direction of vehicle travel. Furthermore, it is not suitable for any alternate uses.

Other ladder covers have been known to employ an auxiliary pocket for accommodating objects such as tools at the top of the ladder. An example of such a cover for a ladder is shown in U.S. Pat. No. 4,726,446 issued to Perbix entitled “Protection Cover for Ladder.” However, there are no structures that could function as handles to permit the use of this device as a tool carrier. Like the Mobley ladder jacket, the Perbix cover is made only of flexible material and is of a rectolinear box shape. It therefore cannot present an aerodynamic surface for the ladder while in transport and it is suitable for no alternate uses.

There is therefore a need in the art for a convenient and easy-to-use ladder cover which provides an aerodynamic surface while in transport and which has alternate uses.

### SUMMARY OF THE INVENTION

In order to meet the need in the art described above, the present Aerodynamic Ladder Cover has been devised to provide an aerodynamic shape to the leading edges of the ladder while in transport. The cover includes a rigid curved forward-facing nosepiece. The nosepiece is substantially semi-cylindrical and its rigidity maintains a smooth-contoured convex surface facing the wind. In one embodiment of the invention, the rigid nosepiece is provided as an insert within layers of a soft cover overlying material. In this embodiment of the invention, the ladder cover is attached to the ladder by straps which extend from a back end of the cover. The straps may be applied around rungs of the ladder and tightly secured by adjustable buckles. In this embodiment of the invention, the construction of the ladder cover and straps permits the cover to be conveniently used as a contractor's tool bag. In this use the cover is oriented with the nosepiece facing downward and the straps providing convenient handles for carrying the bag. The rigid nosepiece permits the soft bag to retain its shape even when heavy tools are carried.

More specifically, the applicant has invented an aerodynamic ladder cover comprising a cover encasing one end of the ladder having a convex rigid nose portion lying entirely across the end of the ladder. The cover further includes two opposing side portions affixed to the nose portion for extending lengthwise along opposite sides of the ladder, and top and bottom portions affixed to the nose portion and the side portions to surround all sides of the ladder. The cover further includes attachment means, preferably straps, affixed to a cover opening opposite the nose portion which receives the end of the ladder. The straps include length-adjusting buckles. A convex semi-cylindrical shape of the nose portion is obtained by a rigid nosepiece insert enclosed between layers of the flexible canvas material of the cover.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a top right front isometric view of the ladder cover in place secured over the end of a typical extension-type ladder, which in this figure is shown in phantom.

FIG. 3 is a top sectional plan view taken from FIG. 1 as shown in that figure.

FIG. 2 is a right side sectional elevation view taken from FIG. 1 as shown in that figure.

FIG. 4 is a top rear right side isometric view of the ladder cover shown inverted and oriented vertically for use as a tool bag.

### DESCRIPTION OF THE PREFERRED EMBODIMENT

Referring now to FIG. 1, the ladder cover of the invention 11 is shown affixed to one end of ladder 13 secured thereto by straps 15 which encircle rungs of the ladder being secured under tension by the adjustment of buckles 17. The end portion of the cover 16 presents a substantially semi-cylindrical convex surface. When in use this surface is forward-facing in the direction of vehicle travel to which the ladder is attached and therefore provides a smooth, aerodynamic contour for the ladder. A rear-facing opening at the opposite end of the cover receives one end of the ladder.

Referring now to FIG. 2, further details of the cover as shown in FIG. 1, including its means of attachment to the ladder, are shown. Cover 11 is preferably made of a flexible material such as canvas. In this embodiment, the nose portion 16 obtains its rigid semi-cylindrical shape by virtue of rigid nosepiece insert 18 which lies between layers of the canvas fabric cover material. The nosepiece may be composed of an appropriately rigid plastic which is both lightweight and durable. As shown in this embodiment, the cover is applied to a typical extension-type ladder 13 which has upper and lower extendable sections 12 and 14 each having rungs 10. In this illustration the straps 15, which extend from the rearmost edge of the cover, loop around two of the ladder rungs rearward of the cover, holding the cover in place by way of the adjustment of buckles 17.

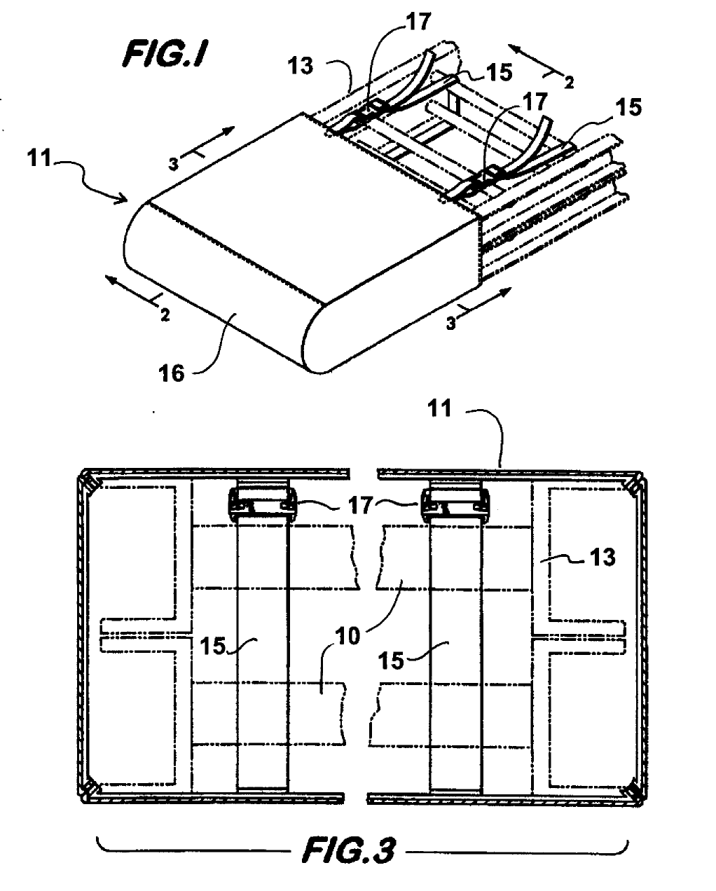

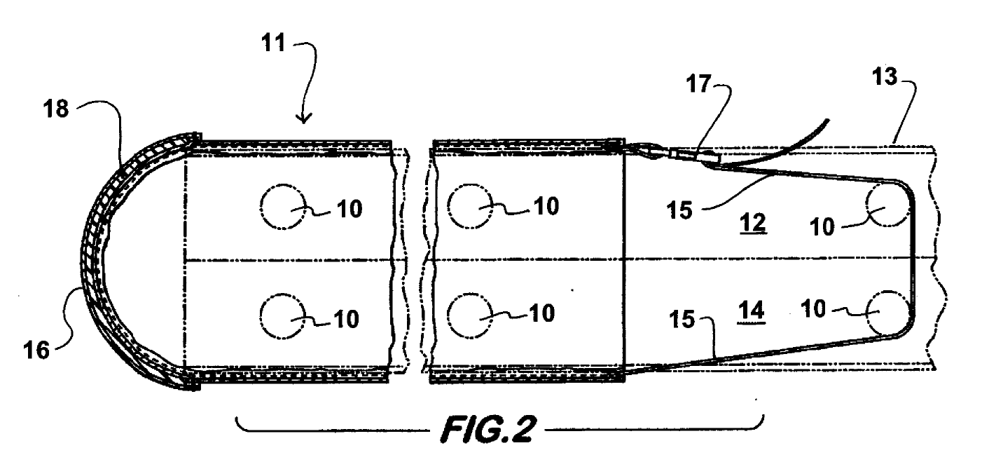

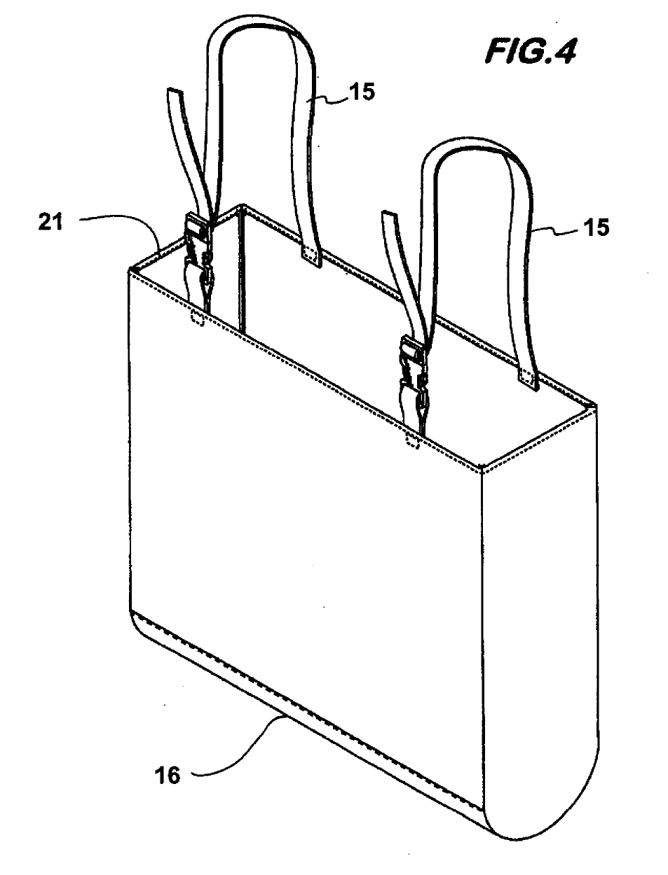

Referring now to FIG. 3, a front sectional view taken from FIG. 1 shows ladder rungs 10 encircled by straps 15 secured in place by buckles 17. Cover 11 includes contiguous top, bottom and side portions a, b, c and d which fully encase all four sides of the ladder.

Referring now to FIG. 4, when removed from the ladder the present ladder cover also serves as a contractors' tool bag. When in this use, the rearward end 21 of the cover 11 can provide an upward-facing open mouth to receive tools or other implements. Straps 15 which are used to secure the cover to the ladder now can be used to provide convenient handles for carrying the bag. Nose portion 16 provides a rigid downward-facing bottom panel which maintains the shape of the tool bag even when heavy tools are carried. As yet another use, the tool holder bag may hang downward from rungs of the ladder when the ladder is leaned at an angle up against a vertical structure such as the side of a building. This provides a convenient storage place where a worker can access various implements or tools while up on the ladder at a significant distance from the ground. Therefore, when used as a tool holder, the present invention can be a carrier or a ladder-mounted accessory.

It should be understood that there may be other modifications and changes to the present invention that will be obvious to those of skill in the art from the foregoing description, however the present invention should be limited only by the following claims and their legal equivalents.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A ladder and aerodynamic cover, in combination comprising:
an elongate ladder having at least one end;
a cover encasing said one end of said ladder comprising:
a convex rigid nose portion lying entirely across said one end,
two opposing side portions affixed to said nose portion for extending lengthwise along opposite sides of said ladder, and
top and bottom portions affixed to said nose portion and said side portions encasing the sides of the ladder.

2. The ladder and cover of claim 1 further including cover attachment means affixed to a cover opening opposite said nose portion.

3. The ladder and cover of claim 2 wherein said attachment means are straps encircling rungs of said ladder.

4. The ladder and cover of claim 3 wherein said straps include length-adjusting buckles.

5. The ladder and cover of claim 1 wherein said nose portion is substantially semi-cylindrical in shape.

6. The ladder and cover of claim 5 wherein said nose portion includes a rigid nosepiece enclosed between layers of flexible material.

7. The ladder and cover of claim 6 wherein said cover material is canvas.

8. A ladder cover comprising:
a cover adapted for encasing one end of a ladder,
a convex rigid nose portion of said cover extending entirely across the width of said cover,
two opposing side portions affixed to said nose portion for extending lengthwise along opposite sides of said ladder, and
top and bottom portions affixed to said nose portion and said side portions for encasing the sides of the ladder.

9. The cover of claim 8 further including cover attachment means affixed to a cover opening opposite said nose portion.

10. The cover of claim 9 wherein the attachment means are straps encircling rungs of said ladder.

11. The cover of claim 10 wherein said straps include length-adjusting buckles.

12. The cover of claim 8 wherein said nose portion is substantially semi-cylindrical in shape.

13. The cover of claim 12 wherein said nose portion includes a rigid nosepiece enclosed between layers of canvas.
